(19) United States
(12) Patent Application Publication
(10) Pub. No.: US 2021/0108457 A1
(43) Pub. Date: Apr. 15, 2021

(54) INSULATED GLAZING UNITS

(71) Applicant: Pellini S.p.A., Codogno (LO) (IT)

(72) Inventors: Marco PASSONI, Copiano (PV) (IT); Alessandro PELLINI, Codogno (LO) (IT); Luca PAPAIZ, Codogno (LO) (IT)

(21) Appl. No.: 16/606,987

(22) PCT Filed: Jan. 29, 2018
(86) PCT No.: PCT/IB2018/050521

§ 371 Date: Oct. 21, 2019

(30) Foreign Application Priority Data
Apr. 24, 2017 (IT) 102017000044591

(51) Int. Cl. E06B 3/67; E06B 9/28

(52) U.S. Cl. CPC E06B 3/6722; E06B 2009/2417; E06B 9/28

(57) ABSTRACT

The present invention relates to an insulated glazing unit (1) comprising a support frame (2); a pair of at least partially transparent panes (3) sealingly fixed to the frame (2) to define a gap (4); a screening element (5) that is adapted to be deployed within said gap (4) to be switched between an open configuration, and at least one closure configuration; a control unit (9) comprising an actuator module (10) associated with the screening element (5) to control deployment of the screening element (5); a pressure sensor (11) configured to send a signal representative of an internal pressure value (Pi) in said gap (4) to the control unit (9).

### TECHNICAL FIELD

The present invention relates to an improved insulated glazing unit as defined in the preamble of claim 1.

### BACKGROUND ART

Insulated glass units are widely used in the field of building and typically have the function of allowing the passage of light while thermally insulating the two environments delimited by the insulated glazing unit.

A known insulated glazing unit comprises an outer frame, which is usually made of metal or plastic sections, to be fitted into a specially designed door or window.

Two parallel panes of glass are sealed to the frame, thereby defining a gap therebetween. Therefore, this gap forms an environment that is separate from both environments external to the insulated glazing unit.

A screening element, namely a blind, e.g. a Venetian blind, is placed within the gap. This screening element may be switched between an open configuration and a closed configuration. In the open configuration light may freely pass through the gap, and in the closed configuration the screening element occupies the gap and blocks light. Various intermediate configurations are also possible, i.e. partially open/closed configurations.

In the known insulated glazing units, the blind is driven by a series of cords wound on a roller. Such roller is typically driven by an electric motor. A control unit is connected to the electric motor to control its operation for deployment of the bind in the insulated glazing unit.

In insulated glazing units exposed to the outside environment air temperature in the gap varies in a rather wide range throughout the year, season after season. Such temperature change results in a corresponding pressure change. Generally, this change is different from that occurring outside the insulated glazing unit, whereby the panes of glass are exposed to a significant differential pressure, which may lead them to bend either inwards or outwards relative to the gap. It will be understood that, in case of inward bending, the useful space for blind movement is considerably reduced and in certain extreme cases may be insufficient. As a result, the blind or the mechanism that controls its movement may be jammed and/or damaged, and damages may also occur to the glass or surface treatments thereof, due to the blind rubbing against the glass.

US 2007/188094 discloses a pressure regulating system for preventing the aforementioned problem in an insulated glazing unit. Special valves are placed on channels that provide communication between the gap of the insulated glazing unit and the outside environment. Pressure sensors are placed in the gap and outside it to allow valve control based on the differential pressure being sensed. The passage of air re-establishes substantial pressure equality between the inside and the outside, thereby preventing glass bending.

### The Problem of the Prior Art

The insulated glazing unit of US 2007/188094 is not permanently hermetically sealed relative to the outside environment, and the valves periodically allow the passage of air withdrawn from the exterior of the insulated glazing unit into the gap of the insulated glazing unit.

Furthermore, a large number of cables are arranged through suitable passages formed in the frame to supply power and/or control the pressure sensor, and such passages do not ensure the seal of the insulated glazing unit.

As a result, moisture and other undesired weather agents may be introduced into the insulated glazing unit, and the smaller thickness of the gap prevents them from escaping out of it. This may lead to fogging and early aging of the screening element and the controls therefor.

Finally, the European standard EN 1279 currently in force and its 2010 release requires insulating glass units (IGUs) to include at least two panes of glass separated by one or more spacers, to be hermetically sealed along its periphery, to be mechanically stable and durable.

The insulated glazing unit of US 2007/188094 does not meet the tightness requirements of this standard.

### Object of the Present Invention

Therefore, the object of the present invention is to provide an insulated glazing unit that can obviate the above mentioned prior art drawbacks.

The aforementioned technical purpose and objects are substantially fulfilled by an insulated glazing unit that comprises the technical features as disclosed in one or more of the accompanying claims.

### Advantages of the Invention

The present invention can provide a hermetically sealed insulated glazing unit that can prevent jamming or malfunctioning of the blind due to weather changes.

Namely, an insulated glazing unit of the present invention comprises a support frame. The insulated glazing unit comprises a pair of panes (or even three, four or more panes of glass), which are at least partially transparent and are sealingly fixed to the frame to define a gap.

The panes and the glass are configured to permanently seal the gap, preferably in compliance with the standard EN 1279, to prevent penetration of moisture and escape of inert gases other than air, which are used to improve the insulating qualities of the insulated glazing unit.

A screening element is adapted to be deployed within the gap This screening element may be switched between an open configuration and at least one closed configuration. In the open configuration light mat pass through the gap. In the closed configuration the screening element at least partially blocks light in the gap.

He insulated glazing unit further comprises a control unit, having an actuation module associated with the screening element to control deployment thereof.

A box for housing the control unit is integrated in the frame.

A pressure sensor is configured to send a signal representative of an internal pressure value to the control unit. The pressure sensor is placed in the box.

Such device can prevent jamming and failures, like in the insulated glazing unit of US 2007/188094. Based on the pressure value sensed by the sensor the control unit can inhibit actuation of the screening element. It shall be noted that this feature may be obtained without requiring fluid communication of the gap with the outside environment.

Since the sensor is placed in the box, the power cables therefor can be also passed in the same hermetically sealed passages that may be provided for the control unit and for the means for driving the screening element. No additional dedicated passages are provided for the sensor cables through the frame or the panes of glass.

Therefore, the device solves the intended technical problem, thereby ensuring compliance with the standards concerning air tightness while also avoiding the movement of the screening element when the pressure values indicate a risk of jamming.

### LIST OF DRAWINGS

Further features and advantages of the present invention will result more clearly from the illustrative, non-limiting description of a preferred, non-exclusive embodiment of an insulated glazing unit as shown in the annexed drawings, in which:

FIG. 1 is a partially exploded perspective view of an insulated glazing unit of the present invention; and

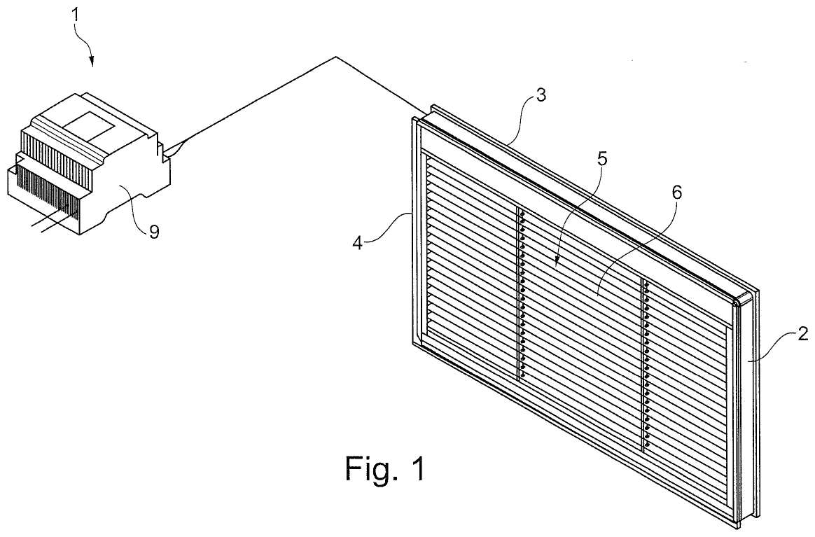

FIG. 2 is a block diagram that shows the operation of the insulated glazing unit of FIG. 1.

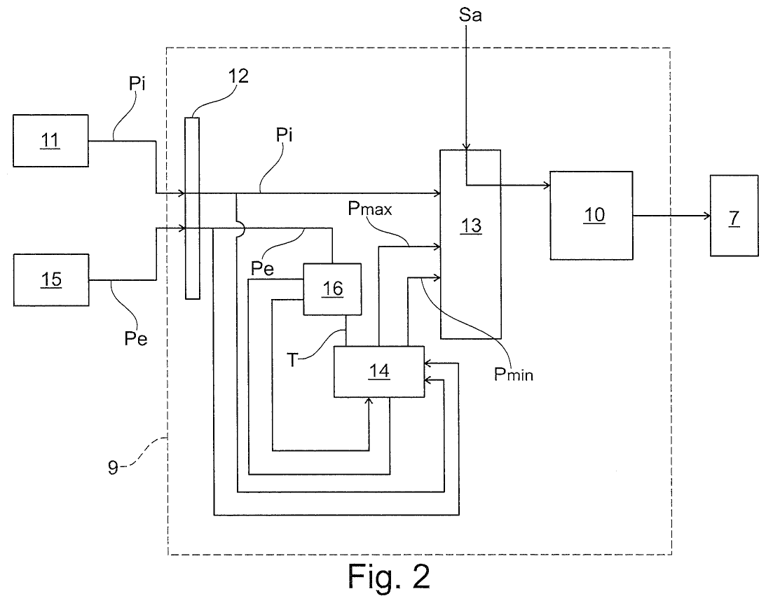

### DETAILED DESCRIPTION

Even when this is not expressly stated, the individual features as described with reference to the particular embodiments shall be intended as auxiliary to and/or interchangeable with other features described with reference to other exemplary embodiments.

Referring to the annexed figures, numeral 1 generally designates an insulated glazing unit of the present invention. The insulated glazing unit 1 comprises a support frame 2. Two at least partially transparent panes 3, preferably made of glass, are sealingly fixed to the frame 2. Thus, the panes 3 define a gap 4.

The panes 3 and the frame 2 are configured to permanently seal the gap 4, i.e. to prevent air from flowing between the gap 4 and the outside environment while preventing any inert gases other than air, introduced into the gap to improve heat insulation properties, from escaping from the gap. In other words, no channels for access to the gap 4 are provided through the panes 3 and/or the frame 2 for the passage of air. Since the panes 3 are sealingly installed on the frame 2, the gap 4 is insulated relative to the outside environment.

Preferably, the panes 3 and the frame 2 are configured to hermetically seal the gap 4 in compliance with the European Standard EN 1279. More in detail, the panes 3 and the frame 2 define an insulating glass unit (IGU) according to such standard.

Namely, the hermetic seal of the insulated glazing unit is permanent and is not subjected to any fluid exchange with the outside environment.

The structure of the frame 2 and the panes 3 is known in the art and will not be further described herein.

A screening element 5 is adapted to be deployed in the gap 4 to change the amount of light that passes through the insulated glazing unit 1. Such screening element 5 may comprise, for example, a Venetian blind, that is designed to have gathering slats or other.

Namely, the screening element 5 may be switched between an open configuration and at least one closed configuration. In the open configuration, the blind 6 is entirely lifted to allow light radiation to pass through the gap 4 without being hindered. In the possible closed configurations, the screening element 5 at least partially blocks light radiation in the gap 4. Here, the blind 6 is partially or entirely lowered.

The insulated glazing unit 1 comprises drive means 7 for lifting and lowering the blind 6. These drive means 7 may comprise, for instance, a roller and an electric motor (not shown).

The insulated glazing unit 1 comprises a box 8 for housing the aforementioned drive means 7 for the screening element 5. Particularly, the box 8 defines a chamber that houses the drive unit 7. Such box 8 is preferably integrated in the upper portion of the frame 2, to form a single environment with the gap 4.

In other words, the pressure of the box 8 and particularly in the chamber is the same as the pressure in the gap 4. This is because the chamber is permanently sealed with respect to the outside environment by the frame 2.

The insulated glazing unit 1 also comprises a control unit 9. Such control unit 9 is particularly configured to communicate with the drive means 7 of the blind 6 to control them. Preferably, the control unit 9 is housed in the box 8 and particularly in its chamber.

In order to control the drive means 7 for driving the blind 6, the control unit 9 comprises a plurality of functional modules, as described below. This depiction of the control unit 9 is given for the sake of a better description of its operation. The actual implementation of the control unit 9 shall not be intended to be limited by this description but may be provided in any manner that is known to the skilled person and may comprise hardware and/or software means.

The control unit 9 may be provided as a single device or may be divided into distinct functional parts, each comprising one or more of the aforementioned modules. The parts that compose the control unit 9 may be integrated into a single circuit or may communicate with each other through wired and/or wireless connections and/or via a local area network and/or via the Internet.

The control unit 9 comprises an actuator module 10 associated with the screening element 5 to control deployment thereof. Namely, the control unit is operable on the drive means 7. In normal operating conditions, the user sends an appropriately encoded actuation signal “AS” to the control unit 9 through a controller (not shown) and, in response to such signal, the control unit 9 controls the drive means 7 to deploy or retract the screening element 5.

The insulated glazing unit also comprises a plurality of cables to supply power to the control unit 9 and/or the drive means 7.

It shall be noted that the frame 2 has one or more hermetically sealed cable raceways (also known as corner raceways) for the passage of such cables (not shown). The power cables extend from the box 8 and more in detail from its chamber, to the outside environment, through respective cable raceways. Each cable raceway may house one or more cables, e.g. In the case of multipolar cables.

Each cable raceway may be implemented, for example, as disclosed in EP2551437 by the Applicant hereof, whose teachings are intended to be incorporated herein in their entirety.

The insulated glazing unit 1 also comprises a pressure sensor 11. The pressure sensor 11 is particularly placed within the gap 4 or, preferably, in the box 8 and particularly in its chamber.

According to a preferred embodiment of the invention, the pressure sensor 11 is integrated in the circuit of the control unit 9.

Since the pressure sensor 11 is accommodated in the box 8, it may be advantageously powered through the power cables. Advantageously, one sealed cable raceway may be sufficient for cables that simultaneously power the pressure sensor 11, the control unit 9 and the drive means 7, whereby the number of openings for the passage of the cables may be restricted, and the insulated glazing unit may be ensured, in compliance with EN1279.

The pressure sensor 11 has the purpose of sensing the internal pressure “Pi”. Therefore, the pressure sensor 11 is configured to send 9 a signal representative of an internal pressure value “Pi” to the control unit 9.

The control unit 9 also comprises an acquisition module 12 which is interfaced with the pressure sensor 11 to receive the signal “Pi”.

The control unit 9 further comprises a comparison module 13, which is namely interfaced with the acquisition module 12. Such comparison module 13 is configured to compare the internal pressure value “Pi” as sensed, and a minimum reference pressure value “Pmin”.

In accordance with the result of such comparison, the actuation module 10 allows or prevents the action of the drive means 7 and, as a result, the deployment for the screening element 5. Particularly, the comparison module 13 is configured to actuator module (13 is configured to prevent deployment of the screening element 5 if the internal pressure value “Pi” is smaller than the minimum reference pressure value “Pmin”.

The comparison module 13 is configured to compare the internal pressure value “Pi” with a maximum reference pressure value “Pmax”.

Here, the actuation module 10 is configured to prevent deployment of the screening element 5 if the internal pressure value “Pi” is greater than the maximum reference pressure value “Pmin”. In other words, if the control unit 9 detects that the pressure conditions do not allow deployment of the screening element 5, it does not perform this operation even once it has received the signal “Sa” as mentioned above.

In a first embodiment of the invention, the reference values “Pmax” and “Pmin” are preset in a memory module 14 and are retrieved into the comparison module 13 as needed.

Particularly, these reference pressure values “Pmax” and “Pmin” represent the maximum and minimum internal pressure values that the manufacturer has determined for that type of insulated glazing unit according to the thicknesses of the pans of sheet 3, the width and height dimensions of the insulated glazing unit, environmental conditions of productions (pressure, temperature and humidity of the establishment of production), as well as the assumed values or the average of the environmental conditions in which it will be installed the insulated glazing unit 1.

The comparison of the internal pressure P1 as sensed with the ideal internal pressure values “Pmin” and “Pmax” provides great advantages because, since the insulated glazing unit is sealed, the amount of air in the gap is decided during assembly, and hence represents a sort of historical memory of pressure.

Thus, considering the problem of preventing jamming of the screening element 5 if the panes 3 bend inwards, the value of the internal pressure as measured Pi may be compared with the only stored value of the ideal internal minimum pressure P1, as the latter is the pressure that is found when the insulated glazing unit has been sealed, i.e. when the panes were necessarily parallel.

Therefore, if the control unit 9 detects a negative differential pressure (between the internal pressure as measured Pi and the ideal Pmin) this implies there is most likely bending toward the interior of the glass.

Here, the insulating glazing unit will not necessarily include a pressure sensor dedicated to sensing of the pressure outside the insulated glazing unit, which will reduce the number of sensors and especially limit the number of cables that must be led to the control unit.

In a second embodiment of the invention, the insulated glazing unit 1 comprises an additional pressure sensor 15.

The additional pressure sensor 15 is placed outside the gap 4, to sense a pressure outside the insulated glazing unit 1.

Therefore, the additional pressure sensor 15 is configured to send 9 a signal representative of an external pressure value “Pe” to the control unit 9. Particularly, the external pressure value “Pe” represents the value of the pressure of the environment in which the insulated glazing unit 1 is installed.

In this case, the insulated glazing unit 9 comprises a computing module 16 which is configured to compute the reference minimum pressure value “Pmin” according to the external pressure value “Pe”. The computing module 16 may calculate the maximum reference pressure value “Pmax” according to the external pressure value “Pe”. By way of mere example, the minimum and maximum reference pressure values “Pmin” and “Pmax” may be obtained by summing and subtracting a predetermined tolerance value “T”, saved in the memory module “T” to and from the external pressure “Pe”. The computed “Pmax” and “Pmin” may be saved in the memory module 14.

It shall further noted that the computing module 9 can save a plurality of measured external and internal values, “Pe” and “Pi”, in the aforementioned memory module 14.

Advantageously, these values are useful in troubleshooting step of glazing unit 1 both as regards the operation of the drive means 7 that for the screening element 5. Additionally, since pressure may be used to calculate the internal temperature of the insulated glazing unit 1, the save values are also useful to assess the thermal insulation performance of the insulated glazing unit 1, as well as its behavior in response to solar radiation.

Those skilled in the art will obviously appreciate that a number of changes and variants as described above may be made to fulfill particular requirements, without departure from the scope of the invention, as defined in the following claims.

1. An insulated glazing unit, comprising:
a support frame;
a pair of at least partially transparent panes sealingly attached to the support frame to define a gap therebetween;
a screening element that is adapted to be deployed in the gap to switch between an open configuration, in which light radiation may pass through the gap, and at least one closing configuration, in which the screening element at least partially blocks the light radiation in the gap;
a control unit comprising an actuator module associated with the screening element to control deployment of the screening element;
a box integrated in the support frame, wherein the control unit is housed in the box; and
a pressure sensor, which is configured to send a first signal representative of an internal pressure value in the gap to the control unit;
wherein the panes and the support frame are configured to hermetically seal the gap in compliance with European Standard EN 1279,
wherein the pressure sensor is in the box,
wherein no channels for access to the gap are provided through the panes, the support frame, or the panes and the support frame for passage of air,
wherein the box defines a chamber that is permanently sealed with respect to an outside environment by the support frame, and
wherein the pressure sensor is housed in the chamber.

2-3. (canceled)

4. The insulated glazing unit of claim 1, further comprising:
a plurality of cables for supplying power to the control unit and the pressure sensor;
wherein the support frame has one or more hermetically sealed cable raceways for passage of the cables.

5. The insulated glazing unit of claim 1, wherein the pressure sensor is integrated with the control unit.

6. The insulated glazing unit of claim 1, further comprising:
drive means for driving the screening element;
wherein the drive means is associated with the actuator module to be controlled by the control unit.

7. The insulated glazing unit of claim 6, wherein the drive means is housed in the box.

8. The insulated glazing unit of claim 1, wherein the control unit further comprises a comparison module which is configured to compare the internal pressure value and an ideal minimum reference pressure value.

9. The insulated glazing unit of claim 8, wherein the actuator module is configured to prevent the deployment of the screening element if the internal pressure value is less than the ideal minimum reference pressure value.

10. The insulated glazing unit of claim 8, wherein the comparison module is configured to compare the internal pressure value and a maximum reference pressure value.

11. The insulated glazing unit of claim 10, wherein the actuator module is configured to prevent the deployment of the screening element if the internal pressure value is greater than the maximum reference pressure value.

12. The insulated glazing unit of claim 1, further comprising:
an additional pressure sensor which is placed outside the gap and is configured to send a second signal representative of an external pressure value to the control unit.

13. The insulated glazing unit of claim 12, wherein the control unit further comprises a computing module which is configured to compute the reference minimum pressure value according to the external pressure value.

14. The insulated glazing unit of claim 1, wherein the control unit further comprises a memory module for storing a reference maximum pressure value and/or a reference minimum pressure value and/or a plurality of external pressure values and/or a plurality of internal pressure values.

15. The insulated glazing unit of claim 9, wherein the comparison module is configured to compare the internal pressure value and a maximum reference pressure value.

16. The insulated glazing unit of claim 15, wherein the actuator module is configured to prevent the deployment of the screening element if the internal pressure value is greater than the maximum reference pressure value.
